(19) United States
(12) Patent Application Publication
(10) Pub. No.: US 2012/0060558 A1
(43) Pub. Date: Mar. 15, 2012

(54) PROCESS AND APPARATUS FOR LASER-SUPPORTED GLASS FORMING

(76) Inventors: Georg Haselhorst, Mainz (DE); Thomas Risch, Mainz (DE)

(21) Appl. No.: 13/231,349

(22) Filed: Sep. 13, 2011

(30) Foreign Application Priority Data
Sep. 13, 2010 (DE) 102010045094.4-45

(51) Int. Cl. C03B 23/00; C03B 18/22

(52) U.S. Cl. 65/29.21; 65/269; 65/111

(57) ABSTRACT

Reducing the adjustment complexity during the forming of glass products, such as the forming of glass tubes to obtain syringe bodies. The glass of a glass pre-product may be heated to be formed, a laser may be used that emits light having a wavelength for which the glass of the glass pre-product is at most partially transparent so that the light is at least partially absorbed in the glass.

### CROSS-REFERENCE TO RELATED APPLICATIONS

This application claims benefit from German Patent Application No. DE 10 2010 045 094.4-45, filed Sep. 13, 2010, the contents of which is hereby incorporated by reference in its entirety.

### DESCRIPTION

The invention concerns in general the production of glass products. In particular, the invention relates to the production of preferably hollow-bodied glass products by laser-supported hot forming.

The shaping of a cone is an essential step of the process of producing, for example, glass syringes. Ordinarily, processes are used for this purpose that utilize fossil fuel-fired burners to heat the glass. The customary process of shaping includes several successive heating and shaping steps by which, starting from bodies of tubular glass, the desired final geometry is approached. Customary diameters of the tubular glass used range between 6 and 11 millimeters.

Devices in which the forming is accomplished with burners in several steps are known, for example, from DE 10 2005 038 764 B3 and DE 10 2006 034 878 B3. These devices are designed as rotary tables.

The repeated alternation of heating and glass forming steps is necessary because the glass blank to be formed is cooled down by the forming tools so that forming in a single forming step has so far been impossible. Such procedures are often realized on indexing rotary table machines since such devices operate economically and have a space-saving design. For example, rotary tables comprising 16 or 32 stations are known. The breakdown of the shaping process into individual stations results in a multiple controlled variables or degrees of freedom which, for example, can be adjusted by manual adjusting processes for refining the entire process. However, especially when introducing heat by means of fossil fuel burners, there are many degrees of freedom. In this case generally a visual evaluation of the flame and the state of the glass, or of the temperature and the distribution thereof, is necessary.

The multiple of degrees of freedom or adjustable parameters at the individual stations also permits various process sequences to be carried out by different combinations and/or sequences of intermediate steps during glass forming, which, however, should ultimately lead to identical results. Given the multiplicity of adjustable parameters as well as the lack of scaling and/or scalability of the process control, the actions of the equipment operator are of great importance for the quality of the end product as well as the performance of the manufacturing process.

Even if, in addition to the implementation of the shaping process on rotary table machines, which is comparatively cost-effective as a result of the basic principle, additional investments in costly automation functions can be avoided, production is nevertheless highly dependent on the availability of experienced and well-trained operating personnel. This results in significant personnel costs in terms of the production costs.

As early as the startup phase of production, costly fine adjustment of all relevant actuating elements in the equipment is necessary. Thus, the existing rotary table machines comprise a plurality of chucks, for example, 16 or even 32 chucks, for cone forming. For this purpose, typically a time frame ranging from several hours to several days, including the run-in process, is required to achieve a stable process flow. In addition, generally even during production, readjustments are necessary to the plurality of stations.

In addition, breaking-in phenomena can have an effect on the fabrication process. These breaking-in phenomena arise, among others, due to thermal expansions caused by the heating of the parts of the equipment by the burners.

It is thus the object of the invention to provide an apparatus and a forming process with which the adjustment complexity can be considerably reduced and the production process stabilized, while at least maintaining the same quality of the glass products that are produced.

This object is achieved by the subject matter of the independent claims. Advantageous refinements of the invention are provided in the respective dependent claims. Accordingly, the invention provides for an apparatus for forming glass products, comprising
a device for locally heating an area of a glass pre-product to above the softening point thereof, and
at least one forming tool for forming at least one section of an area of the glass pre-product heated by the device for local heating, wherein the device for local heating
comprises a laser,
wherein a rotation device is provided in order to rotate the forming tool and the glass pre-product relative to each other, and wherein
the forming tool is designed so that a surface region of the section of the glass pre-product to be formed is not covered by the forming tool, wherein the laser, or a lens system connected downstream of the laser, is arranged such that, during the forming process, the laser light irradiates the region not covered by the forming tool, and wherein a control device is provided that controls the laser in such a way that at least at times the glass pre-product is heated by the laser light during forming.

In order to heat the glass of the glass pre-product to be formed in the apparatus, a laser is used that emits light having a wavelength for which the glass of the glass pre-product is at most partially transparent so that the light is at least partially absorbed in the glass.

The process for forming glass products that can be carried out by this apparatus is the accordingly based on:
heating a local region of a glass pre-product to above the softening point thereof, and
using at least one forming tool to form at least one section of a region of the glass pre-product heated by a device for local heating, wherein the device for local heating
comprises a laser, which
emits light having a wavelength for which the glass is at most partially transparent, so that the light is at least partially absorbed in the glass, and which is focused on the glass pre-product,
wherein the forming tool and the glass pre-product are rotated relative to each other by a rotation device, and wherein
the forming tool is designed so that a surface region of the section of the glass pre-product to be formed is not covered by the forming tool, and wherein
the laser, or a lens system connected downstream of the laser, is arranged such that, during forming, the laser light is not irradiated on the regions covered by the forming tool, and wherein by means of a control device the laser is controlled in such a way that at least at times the glass pre-product is heated during the forming process by the laser light.

Generally, infrared lasers are particularly suited for use as the lasers since the transmission of glass typically decreases from the visible spectral range toward the infrared region. The wavelength of the laser is preferably selected such that, at this wavelength, the glass of the glass object to be worked has an absorption coefficient of at least 300 m⁻¹, and still more preferably at least 500 m⁻¹. At an absorption coefficient of 300 m⁻¹, approximately 25% of the laser power is absorbed upon passing through the walls of a glass tube having a wall thickness of 1 mm. At an absorption coefficient of 500 m⁻¹, as much as approximately 60% of the light is absorbed and can be utilized for heating the glass object.

For forming of syringe bodies, in general lasers having a radiant power less than 1 kW are sufficient to assure sufficiently rapid heating of the glass product. To maintain the temperature during the forming process, generally even less power is needed. For this purpose frequently a radiant power of less than 200 watts is sufficient. A preferred range of the irradiated power is between 30 and 100 watts. For forming larger glass objects, for example for forming glass objects from glass tubes having a diameter of 20 millimeters or more, however, greater power may optionally be beneficial to assure rapid heating. By way of example, in this context the forming of the bottleneck for drug bottles manufactured from glass tubes having diameter of 20 to 30 millimeters shall be mentioned.

According to a refinement of the invention, the laser is operated at a first power during a heating phase prior to the forming process, and this power is reduced to a second power during the forming process. The second power is preferably lower than the first power by at least a factor of four.

Since according to the invention thermal energy is constantly supplied during the forced forming of the glass pre-product, it is possible to avoid or at least reduce cooling during the forming process. The laser beam is preferably irradiated before the forced forming begins and up to a certain point in time after the start of the forced forming process.

In a preferred embodiment of the apparatus, the forming tool comprises a pair of rolls that is arranged in such a way that the rolls of the pair of rolls roll on the surface of a glass pre-product set in motion by the rotation device.

According to a further embodiment of the invention, however, it is also possible for the forming tool not to roll on the glass pre-product, but rather to have it slide over the glass. In particular, suitable lubricating or parting agents can be used for this purpose. Both embodiments, which is to say with rolling rolls and with a sliding forming tool, can also be used simultaneously or in succession. For example, internal forming of the nozzle or of the syringe cone of a syringe body, or of the channel, can be performed by means of a sliding mandrel, while external forming of the syringe cone is carried out using rolling rolls.

In addition, the apparatus and the process according to the invention are preferably used to form hollow-bodies, and more particularly tubular, glass pre-products. In particular, the forming tool can be designed for compression, preferably radial compression of a section of the hollow-bodied glass pre-product. Such compression is carried out, for example, while forming the cone of a syringe body from a hollow-bodied pre-product shaped in the manner of a glass tube. However, the invention is not applicable only to tubular glass but also for the forming of solid glass rods.

The invention does not merely offer the advantage that cooling of the glass pre-product previously heated by the laser beam during the forced forming of the glass can be compensated for. Rather, the laser radiation, compared with the previously used burners, also offers the advantage of being precisely and finely adjustable. Both in terms of time and location. Therefore, in a refinement of the invention, it is now possible to control or adjust the laser radiation in terms of location or time so that a pre-defined temperature profile is set along the heated section of the glass pre-product. In order to adjust the laser power according to a desired temperature profile, in a simple refinement of the invention a lens system is provided that is connected downstream of the laser and distributes the laser power on the glass pre-product inside the section of the glass pre-product to be heated. According to a first embodiment of the invention, such a lens system can comprise a beam-expanding lens that expands the laser beam in at least one spatial direction. In this way, a typically punctiform beam can be turned into a fan-shaped beam, which irradiates an elongated region of the glass pre-product.

Another alternative or additional option of laser power distribution consists in moving the laser beam over the section of the glass pre-product to be heated or formed. Such a movement can, for example, be achieved with a suitable galvanometer. Also conceivable is a laser comprising a swivel or translational drive. Compared to a rigid lens system, the movement of the laser beam offers the possibility of adapting the profile of the irradiated laser power before and/or during the forming process. For example during forming, a spatial distribution of the intensity of the laser light on the section to be formed may be desirable, which differs from the intensity distribution used for heating. Such a difference may be desirable, for example, in order to compensate for inhomogenous cooling caused by the forming tools. During the forming of a syringe cone in one step, for example, it has been found to be beneficial to use an asymmetrical distribution of the radiant power along the axial direction. This helps to avoid or at least reduce the compression of the cone into the cylindrical tube of the syringe body. When fossil fuel burners are used, on the other hand, typically symmetrical heating over a large surface area is effected, by which regions of the cylindrical tube are also heated and thereby softened so that compression of the cone in the axial direction into the cylindrical part of the syringe body is enabled.

It is generally expedient to distribute the laser power in the direction along the axis of rotation. By the rotational movement, the thermal energy is then uniformly distributed over the circumference of the section of the glass pre-product to be heated, while a certain temperature profile can be adjusted along the axial direction.

The invention now also enables an entirely different design of the forming devices, such as those which are notably used for the production of the syringe bodies. As explained above, presently rotary tables comprising 16 or 32 stations are used for this purpose. The forming process passes from station to station, the final shape being achieved in several steps by the successive use of forming tools. Heat is applied between the forming steps so as to compensate for the drop in temperature during the forming process. Since according to the invention heating takes place during the forming process and a temperature drop can thus be compensated for, according to the invention the entire hot forming process of a section to be formed can be carried out at a single station. In other words, all forming tools employed for forming the section are used in one forming station, the laser beam heating the glass pre-product during the forming process or maintaining it at the intended temperature.

According to this embodiment of the invention, the apparatus thus comprises at least one forming station, wherein said forming station has all the forming tools to carry out all the hot forming steps for producing the final product on one section of the glass pre-product.

This special embodiment is based on the general design of the invention of integrating the sub-steps of conventional forming in a few steps, and ideally in one step, by using a laser. This becomes possible since, during the forming process, the laser energy can be coupled into the glass in a very defined manner both variably and reproducibly due to the good controllability of the power and the local/time distribution thereof.

In a refinement of this embodiment of the invention, similarly to the devices known from the state of the art, again several stations can be employed, in which case according to this refinement of the invention, the stations carry out similar forming steps. In this way, the throughput of such an apparatus can be considerably increased compared to known devices through parallel, identical forming processes.

Even with a single station, in general a considerable advantage in terms of speed can be attained compared with a device comprising 16 or 32 stations having a conventional design. With a conventional device, the time required for a forming step typically ranges around 2 seconds. When assuming 4 forming steps and adding the times needed for five to six intermediate heating steps using burners, the total duration of the forming process is approximately 20 seconds. In contrast, with the invention it is possible to limit the forming duration to the duration of one conventional forming step, or a few such steps. The forming process can thus easily be considerably accelerated. The time for forming a section of the glass pre-product, for example, calculated without the heating time, preferably amounts to less than 15, still more preferably to less than 10, and yet more preferably to less than 5 seconds.

It is also advantageous to adjust the laser power over the course of the process. In particular, the irradiated laser power can be reduced during the forming process relative to the laser power during the heating phase preceding the forming process.

According to another refinement of the invention, the laser power can be controlled by means of a control process implemented in the control device as well as based on a temperature of the glass pre-product measured by a temperature measuring device before and/or during the forming process in order to set a pre-defined temperature or a pre-defined temperature/time profile for the glass pre-product.

In this case, a non-contact measuring device is especially suitable as a temperature-measuring device, such as a pyrometer. With such control, the temperature of the glass can be stabilized within a process window of less than ±20° C., generally even maximally ±10° C.

The invention will be described hereafter in more detail based on exemplary embodiments and with reference to the attached figures. In the drawings, identical reference numbers in the figures denote the same or corresponding elements. In the drawings:

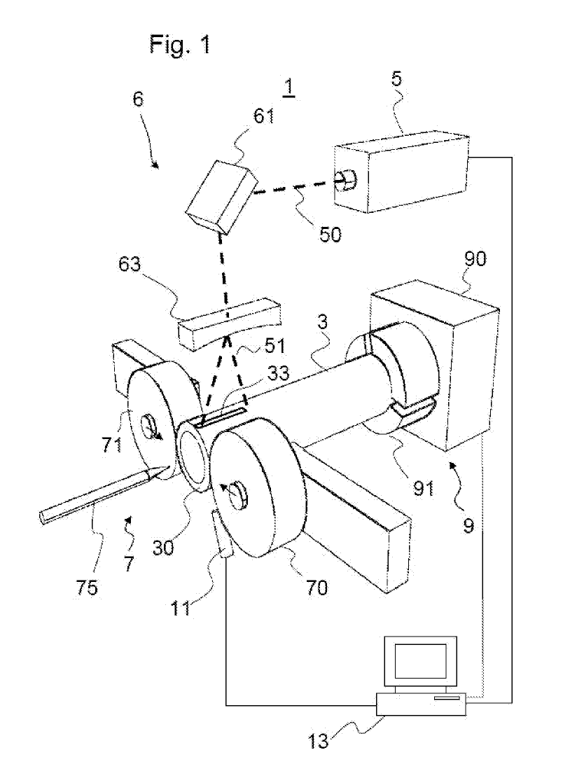

FIG. 1 shows parts of an apparatus for forming tubular glass,

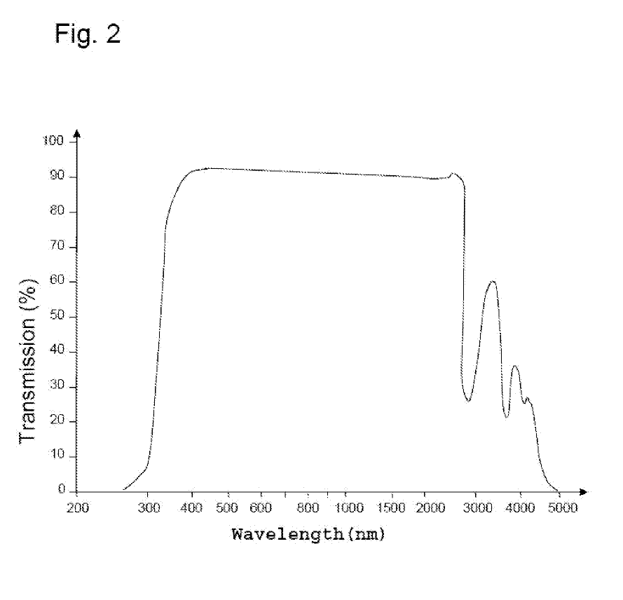

FIG. 2 shows a transmission spectrum of a glass pre-product,

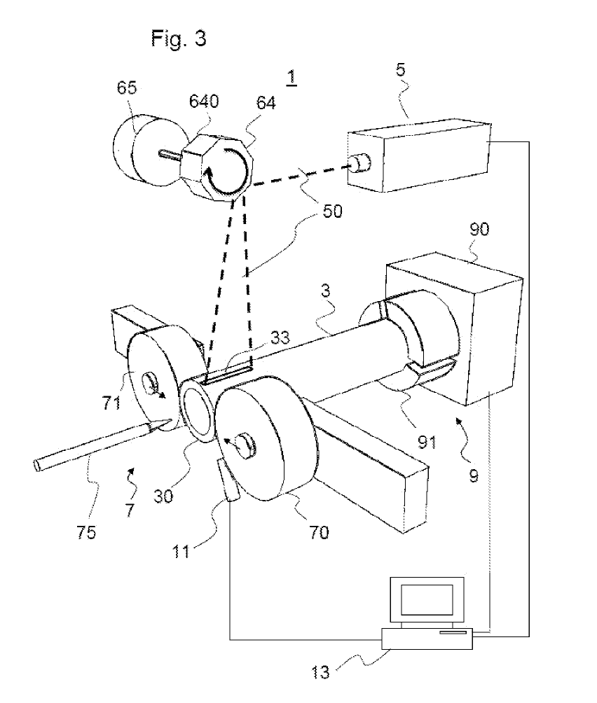

FIG. 3 is a variant of the exemplary embodiment shown in FIG. 1.

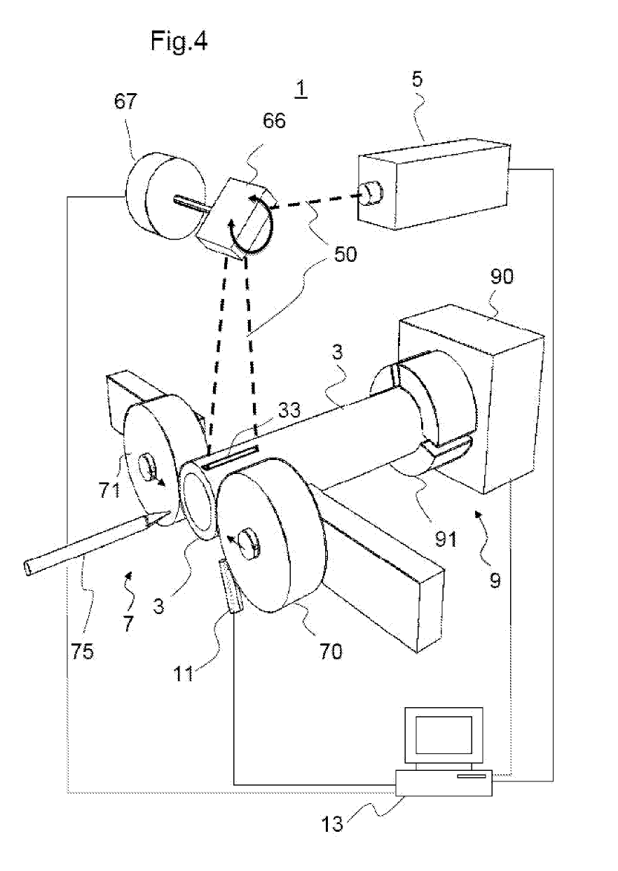

FIG. 4 shows another variant,

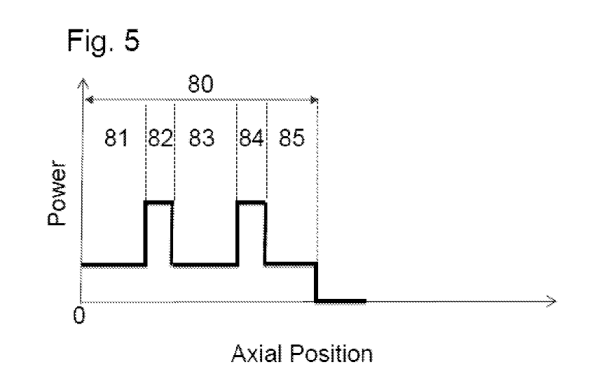

FIG. 5 is a schematic diagram of the irradiated laser power as a function of the axial position along a glass pre-product.

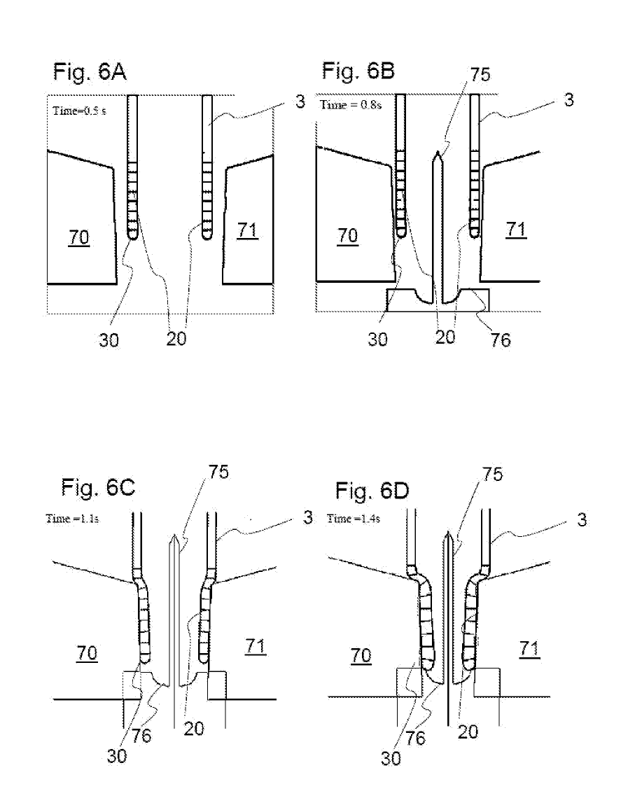

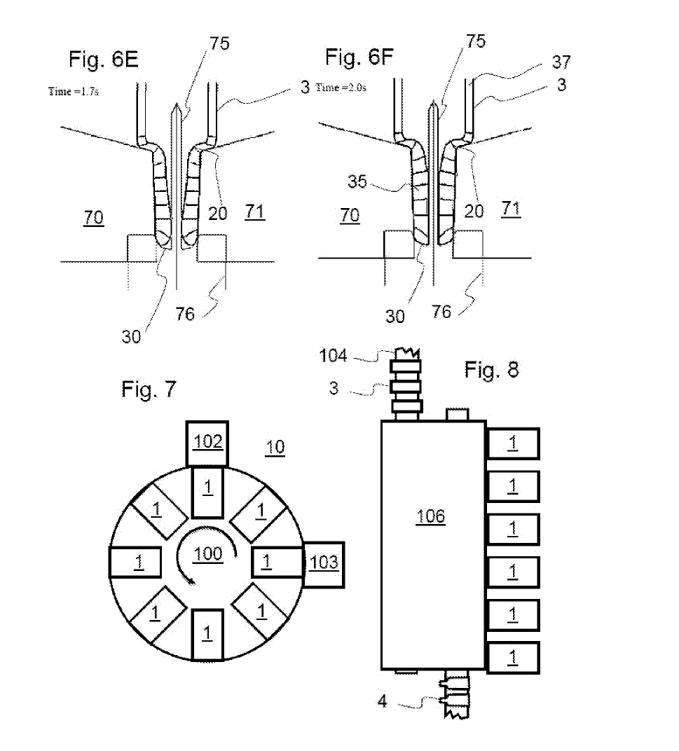

FIGS. 6A to 6F show sectional views of a tubular glass over the course the forming process

FIG. 7 shows a forming system comprising several apparatuses used to form tubular glass, and

FIG. 8 is a variant of the forming system shown in FIG. 7.

FIG. 1 shows an exemplary embodiment of an apparatus 1 for carrying out the process according to the invention.

The apparatus denoted in the overall by reference number 1 of the exemplary embodiment shown in FIG. 1 is designed to form the glass pre-products to obtain glass tubes 3. Specifically, the apparatus is used to produce glass syringe bodies, the cone of the syringe body being formed from the glass tube using the elements of the apparatus 1 shown in FIG. 1.

The production of the cone from the tubular glass by the apparatus 1 is based on the local heating of a region of the glass tube 3, here the end 30 thereof, to above the softening point and forming at least one section of the heated end using at least one forming tool, wherein the device for local heating comprises a laser 5 that emits light having a wavelength for which the glass of the glass tube 3 is at most partially transparent so that the light is at least partially absorbed in the glass. For this purpose, the laser beam 50 is directed by a lens 6 onto the glass tube 3. During the forming process, the forming tool 7 and the glass pre-product 3 are rotated relative to each other by means of a rotation device 9. In general, it is expedient in such cases, as also in the example shown, to rotate the glass tube 3 with the axis of rotation along the axial direction of the glass tube 3. For this purpose, the rotation device 9 comprises a drive 90 having a chuck 91 which holds the glass tube 3. A reverse configuration would also be conceivable, in which the glass tube is held and the forming tool 7 rotated around the glass tube.

In the exemplary embodiment shown in FIG. 1, the forming tool 7 comprises two rolls 70, 71, which roll along the surface of the glass tube 3 as it rotates. In this case, the end 30 of the glass tube 30 is compressed by guiding the rolls toward each other in the radial direction of the glass tube 3. The radial movement is shown in FIG. 1 by arrows on the axes of rotation of the rolls 70, 71. In addition, a mandrel 75 is provided as part of the forming tool 7. This mandrel 75 is inserted into the opening of the glass tube 3 at the end 30 thereof that is to be formed. The conical channel of the syringe body is formed by means of the mandrel 75. The mandrel 75 can be rotatably mounted in order to rotate together with the glass tube 3. It is also possible to allow the rotating glass to slide over the stationary mandrel.

To avoid adhesion, as is usually the case with forming tools sliding over the glass surface, it is advisable to use a parting agent or lubricant, which reduces the friction during the sliding movement. It is also possible to use a lubricant that evaporates at the temperatures used during the forming process. When such a lubricant is used, advantageously the residues of the lubricant and/or parting agent on the finished glass product can be avoided.

Between the rolls 70, 71, it is possible to direct the laser beam 50 onto the glass tube without interruption of the laser beam 50 by the forming tool. Accordingly, the forming tool is designed in such a way that a surface region of the section of the glass tube to be formed is not covered by the forming tool, so that the lens 6 connected downstream of the laser transmits the laser light onto the region not covered by the forming tool during the forming process. Specifically, the laser light illuminates a region 33 located between the rolls 70, 71 on the circumference of the glass tube 3.

A control device 13 controls the forming process. In particular, the laser 5 is controlled by the control device 13 so that at least at times the glass tube 3 is heated by the laser light during the forming process.

The lens system 6 of the apparatus 1 shown in FIG. 1 comprises a deflecting mirror 61 as well as a cylindrical lens 63.

The cylindrical lens 63 expands the laser beam 50 along the axial direction of the glass tube 3 to obtain a fan-shaped beam 51 so that the region 33 illuminated by the laser light is extended accordingly in the axial direction of the glass tube 3. Since the glass tube 3 is rotating while it is irradiated with the laser light, the irradiated power is distributed in the circumferential direction on the glass tube so that a cylindrical section, or, independently of the shape of the glass pre-product generally a section in the axial direction along the axis of rotation, is heated. This section has a length that is preferably at least as great as the section to be formed. The latter has a length that is substantially determined by the width of the rolls. In order to achieve special distributions of the laser power in the axial direction of the glass tube, as an alternative or in addition to the cylindrical lens 63, advantageously a diffractive optical element may be used.

The forming process is controlled by the control device 13. The control device controls the power of the laser, among other things. The movement of the molding tools 70, 71, 75 is also controlled. The rotation device 9 can also be controlled; in this case, the rotational speed of the drive 90 in particular, optionally also the opening and closing of the chuck 91, are controlled.

When forming syringe bodies from glass, generally radiant powers of less than 1 kilowatt are sufficient for the laser 5 to assure a fast heating to the softening point. After the temperature required for hot forming is reached, the control device 1 can adjust the laser power down so that the irradiated laser power only compensates for the cooling. Generally powers between 30 and 100 watts are sufficient for the production of syringe bodies.

The laser power can be controlled in particular based on the temperature of the glass tube 3. For this purpose, a control process can be implemented in the control device 13 that regulates the laser power based on the temperature measured by a temperature-measuring device so as to set a pre-defined temperature or a pre-defined temperature/time profile on the glass pre-product. In the example shown in FIG. 1, a pyrometer 11 is provided as the temperature-measuring device, which measures the thermal radiation of the glass tube at the end 31 thereof that is heated by the laser 5. The measured values are fed to the control device 13 and used in the control process for adjusting the desired temperature.

It is particularly advantageous in one arrangement according to the invention, as shown by way of example in FIG. 1, that the laser light does not heat the forming tool directly. As a result, despite heating of the glass pre-product, the forming tools are generally not heated more strongly during the forming process than in a conventional process using preceding heating by burners. Overall, the apparatus according to the invention generates less thermal energy and this thermal energy is introduced into the glass pre-product even more deliberately. The heating of the entire apparatus, and thus, among others, the breaking-in phenomena resulting due to thermal expansion, are therefore reduced.

A preferred glass for producing syringe bodies is borosilicate glass. A low-alkali borosilicate glass is particularly preferred, notably having an alkali content of less than 10 percent by weight. Borosilicate glass is generally well-suited due to the typically high resistance to temperature fluctuations. This is advantageous with fast processing times such as those which can be achieved by the invention for implementing fast heat-up steps.

A suitable low-alkali borosilicate glass has the following components in percent by weight:

| | | |
|---|---|---|
| SiO₂ | 75 | wt. % |
| B₂O₃ | 10.5 | wt. % |
| Al₂O₃ | 5 | wt. % |
| Na₂O | 7 | wt. % |
| CaO | 1.5 | wt. % |

FIG. 2 shows a transmission spectrum of the glass. The transmission values indicated pertain to a glass thickness of one millimeter.

It is apparent from FIG. 2 that the transmission of the glass drops off at wavelengths above 2.5 micrometers. Above 5 micrometers, the glass is practically opaque, even at very thin glass thicknesses.

The decrease in transmission shown in FIG. 2 in the wavelength range above 2.5 micrometers is not significantly dependent on the exact composition of the glass. Therefore, with similar transmission properties, the aforementioned contents of the components of preferred borosilicate glasses can vary in each case by 25% from the stated value. Furthermore, in addition to borosilicate glass, naturally other glasses may be used as long as they are at most partially transparent at the wavelength of the laser.

FIG. 3 shows a variant of the apparatus shown in FIG. 1. Here too, as in the example shown in FIG. 1, a lens system 6 is provided that is connected downstream of the laser 5 and distributes the laser power on the glass pre-product inside the section of the glass pre-product to be heated, here again the end 30 of the glass tube 3. Instead of a beam-expanding lens system 6 according to the example shown in FIG. 1, however, here the spatial distribution of the radiant power is achieved by the laser beam 50 moving over the section of the glass pre-product to be heated, or formed, in the axial direction, this being along the axis of rotation. For this purpose, the lens system 6 includes an annular mirror or rotating mirror 64 having mirror bevels 640. The rotating mirror 64 is driven and set in rotation by a motor 65. The axis of rotation of the rotating mirror 64 is located transversely, in the example shown in FIG. 3 in particular perpendicularly, to the normal of the mirror bevels. In addition, the axis of rotation is also located transversely, preferably perpendicularly, to the axial direction or to the axis of rotation of the glass tube 3. The rotation of the normal of the mirror bevels 640 thus moves the laser beam 50, depending on the varying angle of the respective illuminated mirror bevels 640, in the axial direction along the glass tube 3, so that in the time average the laser beam 50 illuminates a region 33 on the glass tube, or a correspondingly long axial section of the glass tube 3.

FIG. 4 shows another variant of the apparatus shown in FIG. 1. As in the variant shown in FIG. 3, the laser beam 50 is scanned over a region 33 to distribute the radiant power along the axial section of the glass tube to be heated. For this purpose, the deflecting mirror here is replaced by a pivoting mirror 66, the pivot axis of which runs transversely, preferably perpendicularly, to the axis of rotation of the glass tube 3. The pivoting mirror 66 is pivoted by a galvanometer drive 65 so that the impingement position of the laser beam 50 moves in a corresponding manner to the pivoting movement in the axial direction of the glass tube 3.

An advantage of this arrangement is that the galvanometer drive can be controlled by the control device 13 so that faster and slower pivoting movements, depending on the pivot angle or depending on the axial position of the impingement point, in a simple way can be used to realize illumination times of varying lengths and specific location-dependent power distributions. A refinement of the invention, without limiting the same to the special example shown in FIG. 4, thus provides for a lens system that comprises a beam-deflecting device controllable by the control device so that, by suitable actuation of the beam deflecting device by the control device, a pre-defined location/power profile can be adjusted. With such a profile, a desired location-dependent temperature distribution can then be also produced.

Both with the embodiment of the invention shown in FIG. 3 and that shown in FIG. 4, additionally yet another alternative or additional control is possible in order to enable pre-defined local distributions of the radiant power that is introduced into the glass. For this purpose, a beam-deflecting device is again provided. In order to vary the irradiated power as a function of the location, the power of the laser can be controlled in accordance with the beam deflection by the control device. For example, if a first axial sub-section of the heated axial section should be heated more strongly or less than an adjacent second sub-section, the laser power is regulated up or down accordingly by the control device when the laser beam passes over the first sub-section.

If in the example of the control device shown in FIG. 3 the angle of rotation of the rotating mirror, or of the respective illuminated mirror bevel 640, is known, the control device 13 can adjust the power of the laser 5 accordingly.

FIG. 5 shows for illustration purposes a conceivable distribution of the laser power on the glass pre-product. A diagram is shown of the laser power as a function of the axial position of the impingement point of the laser beam on the glass pre-product. The “0” position identifies the end of the glass pre-product in this case. As is apparent from the diagram, the entire heated axial section 80 in this example is divided into sub-sections 81, 82, 83, 84 and 85. The sub-sections 82 and 84 are irradiated with higher laser power than the adjacent sub-sections 81, 83, and 85. The higher radiant power that is introduced into the sub-sections 82,84 can, as described above, can be accomplished by a controlling the laser power as a function of the position of the beam-deflecting device, in the examples shown in FIGS. 2 and 3 this being as a function of the angle of rotation or pivoting angle of the mirror. Alternatively or additionally, as also described above, the pivoting or rotating speed of the mirror can be varied so that here the axial sub-sections 82, 84 can be illuminated for a longer total time.

Such non-homogeneous deposition of the laser power in the axial direction, as shown in FIG. 5 by way of example, can be of advantage in many respects. For example, if a homogeneous temperature distribution during the forming process is desired, however with non-homogeneous heat dissipation occurring, the inhomogeneity of the heat losses can be at least partially compensated for by adjusting a suitable profile of the irradiated power. For example, sub-sections of the glass pre-product that come into contact first or longer with the forming tool can be heated accordingly more strongly by the laser radiation in order to compensate for the heat losses additionally occurring on the forming tool.

On the other hand, it may also be advantageous to strive for an inhomogeneous temperature profile in the axial direction. Such a temperature profile can be favorable in order to additionally control the flow of material occurring during the forming process. Typically, taking the pressure or tension exerted by the forming tool, glass tends to flow from warmer and therefore softer regions to colder and therefore more viscous regions in the glass pre-product. An advantageous possibility is to reduce the decrease in wall thickness of a glass tube occurring, for example, in regions in which the forming tool causes strong deformation, especially when stretching or bending the glass material.

It can also be very advantageous to induce an intensified flow a material if the wall thickness is increased due to radial compression of a glass tube.

These effects are explained below with reference to FIGS. 6A to 6F. These figures show, based on sectional views, a simulation of a forming process according to the invention to create a syringe cone from a glass tube 3 for producing a syringe body. The sections shown run along the central axis of the glass tube 3 around which the glass tube is rotated. The rolls 70, 71 and the mandrel 75 are also apparent. The laser beam again enters between the rolls so that the direction of irradiation runs perpendicularly to the cutting plane shown.

In addition, the time that has passed since the start of the forming process is also shown. The temporal zero point for the forming process selected was the time at which the laser power is reduced.

The lines 20 drawn in the sectional views of the glass tube, initially running perpendicular to the central axis of the glass tube, characterize imaginary boundaries of axial sections of the glass tube 3. These lines illustrate the flow of material during the forming process.

The mandrel 75 protrudes from a base 76 that is used for forming the front conical area of the syringe. The base 76 is a flat component that is perpendicular to the viewing direction of FIGS. 6A to 6F. As opposed to what is shown, in the actual apparatus the base is rotated 90° about the longitudinal axis of the mandrel 75 so that the base 76 fits between the rolls 70, 71. The overlap of the rolls 70, 71 and base 76, as shown in FIG. 6C, therefore actually does not occur.

Contact of the rolls 70, 71 and the onsetting deformation occur starting with the position shown in FIG. 6C. A compression of the glass tube 3 takes place by the rolls 70, 71 moving radially inward toward the central axis of the glass tube. In the stage shown in FIG. 6E, the mandrel 75 is in contact with the inside of the glass tube and forms the channel of the syringe cone. At the stage shown in FIG. 6F, finally, the forming process of the syringe cone is already completed. Following this, the forming tools are moved away from the formed syringe cone 35. All the forming steps for forming the syringe cone 35 were carried out using the same forming tools 70,71, 75 and the base 76. Such a forming station therefore carries out all the hot forming steps on one section of the glass pre-product. Then, a forming process of the syringe flange, or the finger support at the other end of the glass tube, can be carried out.

Starting with the deforming stage as shown in FIG. 6E, one can clearly recognize that the radial compression at the syringe cone 35 leads to a thickening of the wall thickness. Here the possibility now exists of generating a certain material flow away from the end 30 by adjusting a suitable temperature distribution as described above. Likewise, on the peripheral edges of the formed glass tube, the wall thickness may be reduced in the transition region between the syringe cylinder 37 and syringe cone 35. This effect can also be counteracted by adjusting an axially inhomogeneous power input by controlling the axial distribution of the laser power.

Therefore, the flow direction of the glass can generally be influenced using the temperature control enabled by the laser. In particular, this is also possible with respect to the volume and direction of the glass flow.

It further becomes apparent from FIGS. 6A to 6F that all the forming steps on one section of the glass pre-product, here specifically of a syringe cone, can be completed within a few seconds. The entire forming time in the example of FIGS. 6A to 6F even amounts to less than two seconds.

This entails still other advantages, especially with respect to the production of drug packaging means such a syringes, carpules, ampoules, bottles and the like. Because of the existing long processing times for glass forming, tungsten deposits may develop by abrasion from the forming tool, especially from the mandrel. The invention is therefore especially well-suited for drug packaging means that are free of or very low in tungsten, such as, in particular, syringes, because contamination by the forming tools is reduced as a result of the shortened contact time with the forming tools. In addition, the forming tools are generally heated less by the process according to the invention, which also reduces contamination.

Another advantage of the relatively very short processing time is the reduced alkali overflow when processing glass containing alkalis. When the glass is heated beyond the softening point, generally the alkali ions diffuse to the surface. This effect can be disturbing, notably in the case of drug packaging means, since various drugs are sensitive to alkali metals. The alkali enrichment on the surface is clearly reduced since the forming time by the apparatus according to the invention is considerably shorter than in the case of conventional forming using burners connected upstream of the individual forming stations. Finally, the use of burners can also lead to the input of combustion residues and fine dust.

Based on the effects described above, it becomes clear that a glass product produced by the invention can also be distinguished from glass products formed previously by using burners in terms of the chemical characteristics on the glass surface.

FIG. 7 shows a schematic illustration of an exemplary embodiment of a forming system 10 comprising several forming stations in the manner of the apparatus 1 described above. As opposed to the devices known from the prior art, in which glass pre-products are formed successively in multiple forming stations using several steps, the concept of the embodiment shown in FIG. 7 is based on having the glass tube sections remain in one forming station, or the apparatus 1, during the entire forming process of a section of the glass tube, for example, the shaping of the syringe cone.

In this exemplary embodiment, the forming system 10 comprises a carousel 100 similar to the system known from the prior art for producing glass syringes. Several apparatuses, for example eight apparatuses 1 as shown, are installed on the carousel 100 for the forming of glass products. At an input station 102, the apparatuses 1 are loaded with glass pre-products, such as sections of glass tubes. While the loaded apparatuses 1 are now rotated on the carousel 100 to a withdrawal station 103, the forming process is carried out on the glass pre-products, such as the forming of the syringe cones described in FIGS. 1, 3, 4, 6A-6F, in the apparatuses 1. As opposed to the known forming systems comprising carousels, the forming tools here can be arranged directly on the carousel. A design of the forming system is also conceivable in which the forming stations 1 are stationary and loaded and unloaded parallel to each other. Such a variant is shown in FIG. 8. The glass tubes 3 are fed via a feed device 104, for example, a conveyer belt, to a loading and unloading device 106.

The latter distributes the glass tubes 3 among the apparatuses 1 in which the laser-supported shaping of the syringe cones is carried out. After the forming process, the intermediate or end products in the form of glass tubes 4 having shaped syringe cones are fed from the loading and unloading device 106 to a removal device 107, which transports the formed glass tubes 4 away.

It is obvious to a person skilled in the art that the invention is not limited to the exemplary embodiments described above based on the figures but rather can be varied in numerous ways within the scope of the subject matter of the claims. In particular, the characteristics of individual exemplary embodiments can be combined with each other.

Thus, the invention was described in the figures based on the shaping of the syringe cone of a glass syringe body. The invention, however, can be applied in a corresponding manner not only to the shaping of the finger support of syringe bodies, but also to the forming of other glass pre-products. In particular, the invention is generally well suited for producing drug packaging means from glass. These include not only syringes, but also carpules, bottles and ampoules. The use of the laser as a heating device is not exclusive. Rather, other heating devices may be used in addition. Therefore, it is possible and also even advantageous because of the high heating power to carry out pre-heating by a burner in order to reduce the initial heating time before the forming process.

### LIST OF REFERENCE NUMBERS

1 apparatus for forming of glass products
3 glass tube
4 glass tube having shaped syringe cone
5 laser
6 lens system
7 forming tool
9 rotation device
10 forming system
11 pyrometer
13 control device
20 imaginary boundaries of axial sections of a glass tube 3
30 end of 3 to be formed
33 illuminated area of 3
35 cone
37 syringe cylinder
50 laser beam
51 fan-shaped beam
61 deflecting mirror
63 cylindrical lens
64 annular mirror
65 motor for 64
66 pivoting mirror
67 galvanometer drive
70, 71 rolls
75 mandrel
76 based of 75
80 heated axial section of 3
81-85 sub-sections of 80
90 drive of 9
91 chuck
100 carousel
102 input station
103 withdrawal station
104 feed device
106 loading and unloading device

1. An apparatus for forming glass products, comprising
a device for locally heating an area of a glass pre-product to above the softening point thereof, and
at least one forming tool for forming at least one section of an area of the glass pre-product heated by the device for local heating, the device for the local heating
comprising a laser,
a rotation device being provided for rotating the forming tool and the glass pre-product relative to each other, and
the forming tool being designed so that a surface region of the section of the glass pre-product to be formed is not covered by the forming tool, the laser or a lens system connected downstream of the laser being arranged such that, during the forming process, the laser light irradiates the region not covered by the forming tool, and a control device being provided that controls the laser in such a way that at least at times the glass pre-product is heated by the laser light during forming

2. The apparatus according to claim 1 wherein the forming tool comprises a pair of rolls that is arranged in such a way that the rolls of the pair of rolls roll on the surface of a glass pre-product set in rotation by the rotation device.

3. The apparatus according to claim 1, wherein the forming tool is designed to compress a section of a hollow-bodied glass pre-product.

4. An apparatus according to claim 1 comprising a lens system that is connected downstream of the laser and distributes the laser power onto the glass pre-product within the section of the glass pre-product to be heated.

5. An apparatus according to claim 1 comprising at least one forming station having all the forming tools for carrying out all the hot forming steps for producing the end product on a section of the glass pre-product.

6. An apparatus according to claim 1 comprising a temperature measuring device for measuring the temperature of a glass pre-product before or during the forming process, a control process being implemented in the control device that controls the laser power based on the temperature measured by the temperature measuring device in order to set a pre-defined temperature or a pre-defined temperature/time profile on a glass pre-product.

7. A process for forming glass products, comprising
Locally heating a region of a glass pre-product above the softening point thereof, and
using at least one forming tool to form at least one section of a region of the glass pre-product heated by a device for local heating, said device for local heating comprising a laser, which emits light having a wavelength for which the glass is at most partially transparent, so that the light is at lest partially absorbed in the glass, and which is directed at the glass pre-product, rotating the forming tool and the glass pre-product relative to each other by a rotation device and
the forming tool being designed so that a surface region of the section of the glass pre-product to be formed is not covered by the forming tool, and
the laser, or a lens system connected downstream of the laser, being arranged so that, during the forming process, the laser light irradiates the region not covered by the forming tool, and a control device controlling the laser in such a way that at least at times the glass pre-product is heated by the laser light during forming.

8. The process according to claim 7, comprising controlling or adjusting the laser radiation in terms of location or time in such a way that a pre-defined temperature profile is adjusted along the heated section of the glass pre-product.

9. The process according to claim 7 comprising measuring the temperature of the glass pre-product and controlling the laser power of the laser by the control device based on the measured temperature of the glass pre-product.

10. A process according to claim 7, wherein the laser power irradiated during the forming process is reduced relative to the laser power during a heating phase preceding the forming process.
